(19) United States
(12) Patent Application Publication
(10) Pub. No.: US 2006/0290960 A1
(43) Pub. Date: Dec. 28, 2006

(54) Image printing system and image printing method

(75) Inventor: Masatoshi Matsuhira, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/069,038

(22) Filed: Mar. 2, 2005

(30) Foreign Application Priority Data
Mar. 3, 2004 (JP) 2004-58665
Mar. 2, 2005 (JP) 2005-57311

(51) Int. Cl. G06K 15/00

(52) U.S. Cl. 358/1.12; 358/479

(57) ABSTRACT

An image printing system PS of the invention includes a digital still camera as a moving image data generation device and a printer as a printing device that are mutually connected by a cable. In response to the user's operation of an OK button during reproduction of a selected moving image, the digital still camera specifies one reference frame image selected from the reproduced moving image and outputs print command data with regard to the specified reference frame image to the printer. The printer receives the print command data and prints a still image that is equivalent to the specified reference frame image. This arrangement of the invention takes advantage of the moving image reproduction display functions and the printing functions of the moving image data generation device, such as a digital camera, and of the printing device connected thereto, and thus ensures easy and adequate printing of the user's desired still image included in a moving image with the printing device.

### CLAIM OF PRIORITY

The present application claims priority from Japanese application P2004-58665A filed on Mar. 3, 2004, the content of which is hereby incorporated by reference into this application.

### BACKGROUND OF THE INVENTION

1. Field of the Invention

The present invention relates to an image printing technique that causes a printing device to print an image according to image data received from a moving image data generation device, which is connected to the printing device and takes a moving image of a subject to generate moving image data,

2. Description of the Related Art

Some techniques have been proposed to print a moving image taken with a digital camera (see, for example, Japanese Patent Laid-Open Gazette No. 2001-292404 and No. 2001-309304). One proposed technique records moving image data representing a moving image taken with a digital camera, together with information on a still image selected from the moving image, in a memory card set in the digital camera. A printing device prints the selected still images according to the moving image data and the information recorded in the memory card inserted in the printing device.

This prior art technique requires insertion of a memory card in the digital camera to record the moving image data and the information on the selected still image and subsequent replacement of the memory card to the printing device to print the selected still image. A print start command is to be output to the printing device after the replacement of the memory card. Namely the relatively complicated series of operations is required to print the user's desired still image. When the printing device has no image display functions, the user can not visually check a selected still image as an object of printing prior to an actual printing operation. There is accordingly a possibility that the user's unexpected image is printed mistakenly.

### SUMMARY

The object of the invention is thus to eliminate the drawbacks of the prior art technique of printing still images selected from moving image data and to take advantage of the moving image reproduction display functions and the printing functions of a moving image data generation device, such as a digital camera, and of a printing device connected thereto and thus ensure easy and adequate printing of the user's desired still image included in a moving image with the printing device.

In order to attain at least part of the above and the other related objects, the aspect of the present invention is directed to a first image printing system including a moving image data generation device and a printing device that are connected to each other. The moving image data generation device takes a moving image of a subject to generate moving image data, while the printing device prints an image according to image data received from the moving image data generation device.

The moving image data generation device includes: a reproduction module that reproduces the moving image according to the generated moving image data in a visually recognizable manner; a selection module that selects a still image from the reproduced moving image in response to a user's preset instruction; a specification module that specifies at least one still image in response to the selection by the selection module; and a print command output module that outputs a print command with regard to the specified still image to the printing device.

The printing device receives the print command output from the moving image data generation device and prints a still image that is equivalent to the specified still image.

There is an image printing method corresponding to the first image printing system of the invention. The aspect of the invention is thus directed to a first image printing method that causes a printing device to print a still image on a printing medium according to image data received from a moving image data generation device, which is connected to the printing device and takes a moving image of a subject to generate moving image data.

The first image printing method includes the steps of: reproducing the moving image according to the moving image data in a visually recognizable manner on a display unit of the moving image data generation device; specifying one still image among a large number of still images constituting the reproduced moving image; outputting still image data representing the specified still image and a print command with regard to the specified still image to the printing device, in response to a preset operation of the moving image data generation device; and causing the printing device to print a still image that is equivalent to the specified still image, in response to the input print command.

In the first image printing system and the corresponding first image printing method of the invention, the moving image data generation device takes a moving image of a subject to generate moving image data and outputs image data to the printing device connected thereto. The printing device prints an image according to the image data received from the moving image data generation device. The moving image data generation device and the printing device may have either a wired connection or a wireless connection. The moving image data generation device reproduces the moving image according to the moving image data in a visually recognizable manner (reproduction module), selects a still image from the reproduced moving image in response to the user's preset instruction (selection module), specifies at least one still image in response to the selection (specification module), and outputs the print command with regard to the specified still image to the printing device (print command output module). The printing device receives the print command output from the moving image data generation device and prints a still image that is equivalent to the specified still image. In this arrangement of the invention, the moving image data generation device specifies a still image as an object of printing and sends the print command with regard to the specified still image to the printing device. The first image printing system and the corresponding first image printing method of the invention take advantage of the moving image reproduction display functions of the moving image data generation device and the printing functions of the printing device to ensure easy and adequate printing of the user's desired still image included in a moving image with the printing device. The user is not required to replace a recording medium for recording the moving image from the moving image data generation device to the printing devices or to give a print start command to the printing device after the replacement. This arrangement of the invention desirably simplifies the user's operations required to print a desired still image included in a moving image taken with the moving image data generation device. Even when the printing device has no image display functions, this arrangement enables the user to visually check each desired still image as an object of printing by utilizing the functions of the moving image data generation device, prior to printing. This ensures adequate printing of the user's desired still image.

The first image printing system and the corresponding first image printing method of the invention may be actualized by diversity of embodiments and configurations. These embodiments and configurations are applicable in a substantially similar manner to both the image printing system and the image printing method, although the following description regards only the image printing system.

It is preferable that the selection module selects the still image in response to the user's preset operation of an operation unit during reproduction of the moving image. The user manipulates the operation unit at any desired scene in the reproduced moving image to select the desired still image.

It is also preferable that the print command output module outputs the print command to the printing device in response the user's predetermined operation of an operation unit. The user manipulates the operation unit of the moving image data generation device to send a print command to the printing device. This arrangement enables the user to arbitrarily select the timing of printing a still image.

In one preferable embodiment of the first image printing system of the invention, the moving image data generation device further includes: an option display module that displays the still image selected by the selection module and a still image consecutive to the selected still image as multiple still image options for printing; and a reselection module that reselects a still image among the displayed multiple still image options in response to the user's specified operation of an operation unit during the display. The specification module specifies at least one still image in response to the reselection by the reselection module. Prior to specification of at least one still image as an object of printing, the user is allowed to reselect a desired still image among the displayed multiple still image options, which include the originally selected still image from the reproduced moving image in response to the user's preset instruction and the still image consecutive to the selected still image. This arrangement enables the user to readily determine a desired still image as an object of printing by only a simple operation. The user is thus not required to repeat the selecting operation several times before final determination of a desired still image as an object of printing from the reproduced moving image.

In another preferable embodiment of the first image printing system of the invention, the moving image data generation device further includes a data output module that extracts the at least one still image specified by the specification module from the moving image and outputs still image data representing the extracted still image to the printing device. The printing device receives the still image data output by the data output module and prints the still image according to the received still image data. In this embodiment, the moving image data generation device extracts the still image as an object of printing from the moving image. The structure of this embodiment does not require transfer of moving image data but requires output of only the still image data from the moving image data generation device to the printing device to print the user's desired still image included in the reproduced moving image. This arrangement effectively reduces the data volume output from the moving image data generation device to the printing device for printing.

In still another preferable embodiment of the first image printing system of the invention, the specification module of the moving image data generation device specifies the selected still image and an adjoining still image adjacent to the selected still image. The printing device further includes an image composition printing module that combines still image data representing the selected still image with still image data representing the adjoining still image to generate composite still image data and prints the still image according to the composite still image data. The resulting printed image accordingly has the higher picture quality and the higher clearness than a printed image according to only the still image data representing the selected still image.

In one preferable structure of this embodiment of the first image printing system, the printing device further includes an adequacy judgment module that determines adequacy or inadequacy of image data composition between the still image data representing the selected still image and the still image data representing the adjoining still image, based on a preset criterion. When the adequacy judgment module determines adequacy of the image data composition, the image composition printing module prints the still image according to the composite still image data. The adequacy of the image data composition is determined, prior to actual composition of the still image data representing the selected still image with the still image data representing the adjoining still image. Only the adequacy judgment allows composition of these two still image data, while the inadequacy judgment does not allow composition of these two still image data. This arrangement effectively ensures the improvement in picture quality by the image composition.

The aspect of the invention is also directed to a second image printing system including a moving image data generation device and a printing device that are connected to each other. The moving image data generation device takes a moving image of a subject to generate moving image data, while the printing device prints an image on a printing medium according to image data received from the moving image data generation device.

The second image printing system includes: a reproduction module that reproduces the moving image according to the generated moving image data in a visually recognizable manner; a still image specification module that specifies at least one still image and at least one adjacent still image consecutive to the at least one still image in the reproduced moving image; an image composition module that combines still image data representing the at least one still image with still image data representing the at least one adjacent still image to generate composite still image data; and a printing module that prints a still image according to still image data.

At least part of these modules is incorporated redundantly in both the moving image data generation device and the printing device.

There is an image printing method corresponding to the second image printing system of the invention. Another application of the invention is thus a second image printing method that causes a printing device to print a still image on a printing medium according to image data received from a moving image data generation device, which is connected to the printing device and takes a moving image of a subject to generate moving image data.

The second image printing method includes the steps of: reproducing the moving image according to the moving image data in a visually recognizable manner on a display unit having a moving image display function; specifying at least one still image and at least one adjacent still image consecutive to the at least one still image in the reproduced moving image; combining still image data representing the at least one still image with still image data representing the at least one adjacent still image to generate composite still image data; and causing the printing device to print a composite still image according to the generated composite still image data.

At least part of these steps is redundantly executable by both the moving image data generation device and the printing device.

In the second image printing system and the corresponding second image printing method of the invention, the printing device receives image data from the moving image data generation device connected thereto and prints a still image according to the received image data. The moving image is reproduced in a visually recognizable manner according to the moving image data generated by the moving image data generation device. At least one still image and at least one adjacent still image consecutive to the at least one still image are specified in the reproduced moving image. The composite still image data is generated by combining the still image data representing the at least one still image with the still image data representing the at least one adjacent still image. The printing device is activated to print a composite still image on a printing medium according to the generated composite still image data. In the second image printing system and the corresponding second image printing method of the invention, at least part of these modules or these steps are redundantly arranged in both the moving image data generation device and the printing device. The moving image data generation device and the printing device can thus effectively share the required series of processing to specify at least two still images from the moving image data generated by the moving image data generation device, to combine the still image data of the at least two still images and generate composite still image data, and to print a composite still image according to the composite still image data.

The second image printing system and the corresponding second image printing method of the invention may be actualized by diversity of embodiments and configurations. These embodiments and configurations are applicable in a substantially similar manner to both the image printing system and the image printing method, although the following description regards only the image printing system.

In one preferable structure, among the partly redundant modules of the second image printing system, the reproduction module and the still image specification module are incorporated in the moving image data generation device, while the image composition module and the printing module are incorporated in the printing device. In this structure, the moving image data generation device has the functions of reproducing the moving image and specifying the at least two still images from the reproduced moving image.

In another preferable structure, the reproduction module is incorporated in the moving image data generation module, while the still image specification module, the image composition module, and the printing module are incorporated in the printing device. In this structure, the printing device has the function of specifying the at least two still images from the moving image reproduced by the moving image data generation device.

In another preferable structure, the moving image data generation device has a moving image data output module that outputs the generated moving image data to the printing device. The printing device has all the reproduction module, the still image specification module, the image composition module, and the printing module. The printing device receives the moving image data output from the moving image data generation device, processes the received moving image data, and prints a composite still image according to the generated composite still image data.

In the second image printing system of the invention, execution of a certain processing operation is not fixed to one of the moving image data generation device and the printing device but may be determined adequately through communication between the moving image data generation device and the printing device. In one preferable embodiment of the second image printing system, the moving image data generation device includes: an inquiry module that inquires of the printing device for information on a processing capability of the image composition; a processing allocation determination module that refers to the information on the processing capability of the image composition sent from the printing device in response to the inquiry, and determines allocation of an image processing operation of specifying the still images and an image processing operation of combining the specified still images to the printing device or to the moving image data generation device; and a processing control module that notifies the printing device of the determined allocation of the image processing operations and controls execution of each image processing operation allocated to the moving image data generation device. The allocation of the required image processing operations is determined, based on the result of the inquiry. Different combinations of the moving image data generation device and the printing device have different processing capabilities and performances. The inquiry ensures the optimum share of the required image processing operations to the moving image data generation device and to the printing device.

In one preferable application of this embodiment, the processing allocation determination module refers to the information on the processing capability of the image composition sent from the printing device in response to the inquiry and determines whether the processing capability of the printing device is higher than the processing capability of the moving image data generation device. When it is determined that the processing capability of the printing device is higher than the processing capability of the moving image data generation device, the processing allocation determination module allocates the image processing operation of combining the specified still images to the printing device. The relatively heavy load of the image composition is allocated to the device having the higher processing capability. This desirably shortens the total processing time in the second image processing system. One method of the processing capability assessment sets the higher numerical value to a specific parameter corresponding to the shorter processing time of a predetermined image processing operation. Another method of the processing capability assessment directly or indirectly evaluates the processing capability of each device, based on the processing speed of an internal CPU and the storage capacity of an internal memory.

In one preferable embodiment of the second image printing system of the invention, the moving image data generation device has: a mode selection module that selects either of a moving image mode and a still image mode as image data to be processed; and an image print control module that, in response to selection of the still image mode by the mode selection module, controls the printing module to print the still image according to the still image data without the image composition performed by the image composition module. This arrangement readily changes the required series of image processing in response to selection of a moving image or a still image as object data to be processed.

In another preferable embodiment of the second image printing system of the invention, the moving image data generation device has: a mode selection module that selects either of a moving image mode and a still image mode as image data to be processed; and a composite image print control module that, in response to selection of the moving image mode by the mode selection module, activates the image composition module to generate the composite still image data and controls the printing module to print a composite still image according to the generated composite still image data.

In the structure of the latter embodiment, the moving image data generation device may further include a still image print control module that, in response to selection of the still image mode by the mode selection module, prohibits activation of the still image specification module and the image composition module, directly outputs still image data representing a still image selected from the moving image to the printing module, and controls the printing module to print the selected still image according to the output still image data.

The technique of the invention is also actualized by a moving image data generation device and a printing device included in the image printing system of the invention described above.

### BRIEF DESCRIPTION OF THE DRAWINGS

FIG. 1 schematically illustrates the configuration of an image printing system PS in a first embodiment of the invention;

FIG. 2 is a block diagram schematically illustrating the structure of a digital still camera included in the image printing system PS of the first embodiment;

FIG. 3 schematically illustrates the structure of a printer included in the image printing system PS of the first embodiment;

FIG. 4 shows the configuration of a control circuit included in the printer of FIG. 3;

FIG. 5 is a flowchart showing a series of processing performed by the digital still camera as a routine A1 of an image printing process;

FIG. 6 shows a typical positional relation of object frame images including adjoining frame images to a reference frame image;

FIG. 7 is a flowchart showing a series of processing performed by the printer as a routine B1 of the image printing process;

FIG. 8 shows a positional deviation between a reference frame image and an adjoining frame image;

FIG. 9 is a flowchart showing a series of processing performed by the digital still camera as a routine A2 of an image printing process in a second embodiment of the invention;

FIG. 10 is a flowchart showing a series of processing performed by the printer as a routine B2 of the image printing process in the second embodiment of the invention;

FIG. 11 shows a list of available image processing operations responded by the printer to an inquiry from the digital still camera;

FIG. 12 shows one example of processing capacity responded by the printer to an inquiry from the digital still camera; and

FIGS. 13A through 13C show examples of display on a liquid crystal display of the digital camera in a first modified example.

### DESCRIPTION OF THE PREFERRED EMBODIMENTS

The invention is described in detail with reference to preferable embodiments in the following sequence, in order to clarify the features, aspects, and effects of the invention:

A. First Embodiment
A-1. Configuration of Image Printing System
A-2. Image Printing Process
A-3. Functions and Effects

B. Second Embodiment

C. Modifications

A. First Embodiment

A-1. Configuration of Image Printing System

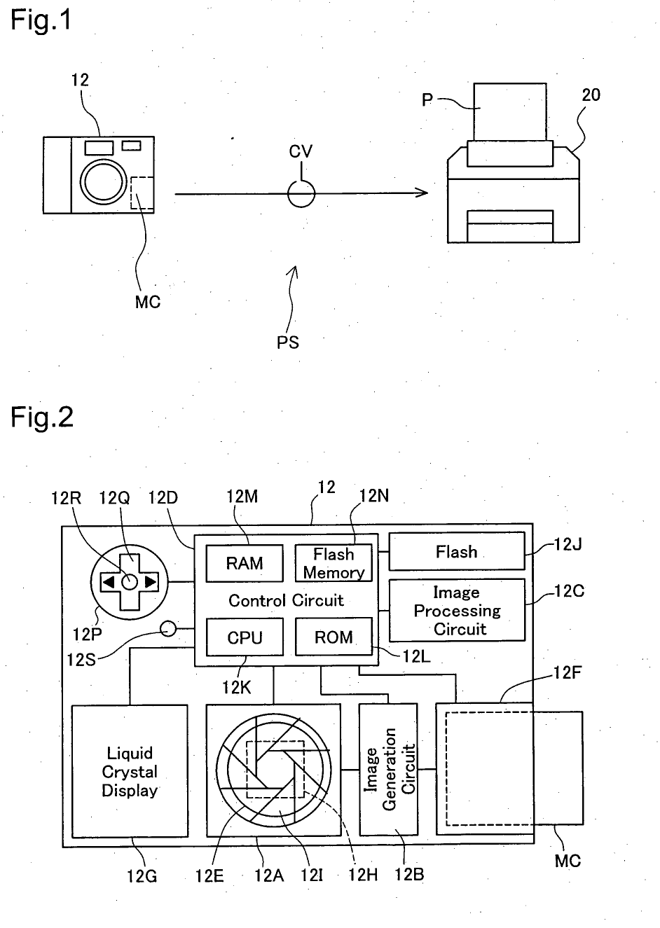

FIG. 1 schematically illustrates the configuration of an image printing system PS in a first embodiment of the invention. The image printing system PS of the first embodiment includes a digital still camera 12 that is designed to take both still images and moving images, and a printer 20 that is connected with the digital still camera 12 by a cable CV and functions as a printing device. The digital still camera 12 of the embodiment that is capable of taking both still images and moving images may be replaced by a digital video camera that is capable of taking only moving images.

The digital still camera 12 is operated to take still images and moving images and to generate digital data that express the still images and the moving images by R, G, and B tone values of respective pixels (hereafter referred to as RGB data). The RGB data representing still images (hereafter referred to as still image data) and the RGB data representing moving images (hereafter referred to as moving image data) are stored in a memory device of the digital still camera 12, for example, in a memory card MC (see FIGS. 1 and 2) or in a flash memory 12N (see FIG. 2). The digital still camera 12 reads the still image data or the moving image data from the memory device and outputs the read still image data or moving image data to the printer 20 via the cable CV. The printer 20 of this embodiment is an inkjet printer that creates dots of six colors, C (cyan), LC (light cyan), M (magenta), LM (light magenta), Y (yellow), and K (black), on printing paper P to print a color image. The printer 20 converts the RGB data input via the cable CV into CMY data in a printable format by the printer 20 and prints a color image according to the CMY data on the printing paper P as a printing medium. The CMY data represents the dot distributions of the respective colors C, LC, M, LM, Y, and K.

FIG. 2 is a block diagram schematically illustrating the structure of the digital still camera 12. The digital still camera 12 focuses light information on a digital device or a photoelectric transducer, such as a CCD or a photomultiplier, to take a still image or a moving image. The optical system of the digital still camera 12 includes a lens 12E for optical image formation and an aperture 121 for regulation of light intensity. The digital still camera 12 has an optical circuit 12A including a CCD 12H that converts the optical image formed by the lens 12E into electric signals, an image generation circuit 12B that controls the optical circuit 12A to obtain an image of a subject and generates image data (still image data or moving image data) representing the obtained image, an image processing circuit 12C that processes the generated image data, and a control circuit 12D that connects with all the other circuits 12A, 12B, and 12C for control. The control circuit 12D is also connected with an input/output terminal (not shown) to receive connection of the cable CV, a flash 12J as an auxiliary light source, and a memory card slot 12F to receive the inserted memory card MC. The memory card MC may be any of diverse memory formats, for example, CompactFlash (registered trademark) of SmartMedia (trademark). The memory card MC is freely attachable to and detachable from the memory card slot 12F.

The control circuit 12D includes a CPU 12K that executes various operations including a still image data generation process of generating still image data from moving image data and series of image processing, and a RAM 12M that temporarily stores diverse data required for execution of the various operations (for example, moving image data and generated still image data). The control circuit 12D also has a ROM 12L that stores an image printing program A1 specifying a series of image printing process (discussed later) and diversity of other control programs, and a writable flash memory 12N that keeps the storage even in the state of no supply of electricity to the control circuit 12D.

The digital still camera 12 stores each still image data or moving image data representing a still image or moving image with its data volume in the flash memory 12L or in the memory card MC. The JPEG format is a typical storage format of still image data in the digital still camera 12, although another format, for example, the TIFF format, GIF format, BMP format, or RAW data format, may also be adopted for storage of still image data. The storage format adopted for moving image data may have a continuous time-series record of multiple still images in respective frames of a moving image (for example, Motion-JPEG format having a continuous record of multiple JPEG images) or may have storage of differential information of each frame relative to adjoining frames for high compressibility (for example, MPEG4 format).

The control circuit 12D of the digital still camera 12 is also connected with a liquid crystal display 12G, an operation unit 12P that is manipulated to set various shooting conditions (for example, the aperture setting and the shooting mode) and display a preview still image or moving image on the liquid crystal display 12G, and a Print button 12S that is pressed to output a print command to the printer 20. The operation unit 12P has an arrow key 12Q and an OK button 12R.

The operations of the arrow key 12Q and the OK button 12R under the display of a preview moving image on the liquid crystal display 12G have meanings specified below. In response to the user's press of a rightward arrow on the arrow key 12Q, the control circuit 12D reproduces a selected moving image in a visually recognizable manner on the liquid crystal display 12G. In response to the user's long press of the rightward arrow on the arrow key 12Q, the control circuit 12D reproduces the selected moving image at a fast speed (fast forward). In response to the user's press of a leftward arrow on the arrow key 12Q, the control circuit 12D reproduces the selected moving image in a reverse direction. In response to the user's long press of the leftward arrow on the arrow key 12Q, the control circuit 12D reproduces the selected moving image in the reverse direction at a fast speed (fast rewind). The user may press the OK button 12R at any arbitrary timing during reproduction of the selected moving image, for example, at a timing of the appearance of a desired scene on the liquid crystal display 12G. The control circuit 12D detects the user's press of the OK button 12R and suspends the reproduction of the moving image. At the pause timing, a still image in the suspended frame (frame image) is then displayed on the liquid crystal display 12G. This means selection of one frame image in the moving image reproduced on the digital still camera 12. Another press of the OK button 12R in the pause state cancels out the selection of the frame image and resumes the reproduction of the moving image.

In the case of reproduction of a moving image stored in the Motion-JPEG format, a JPEG image in the suspended frame is displayed as the frame image. In the case of reproduction of a moving image stored in the format having storage of differential information of each frame relative to adjoining frames, for example, in the MPEG4 format, on the other hand, in response to suspension of the reproduction of the moving image, the control circuit 12D in the digital still camera 12 of the embodiment accumulates the differential information between a first frame and the suspended frame. The control circuit 12D then adds the accumulated differential information to the data representing a still image in the first frame to generate data representing a frame image in the suspended frame. The frame image in the suspended frame is then displayed on the liquid crystal display 12G.

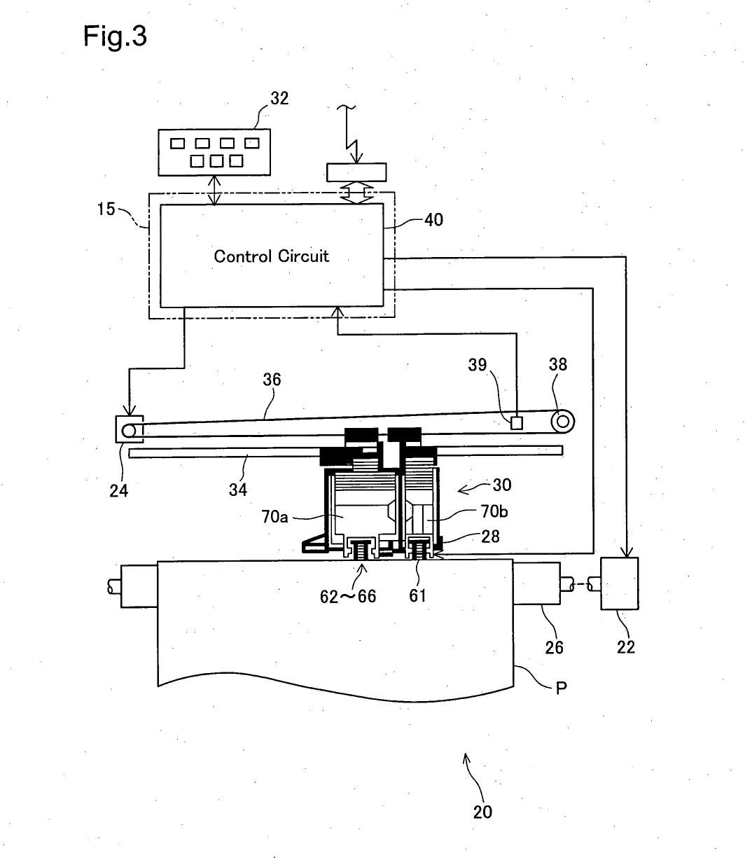

FIG. 3 schematically illustrates the structure of the printer 20. As illustrated, the printer 20 has a mechanism of activating a paper feed motor 22 to feed printing paper P, a mechanism of activating a carriage motor 24 to move a carriage 30 back and forth along a shaft of a platen 26, a mechanism of actuating a print head unit 28 mounted on the carriage 30 to eject inks and create dots, and a control circuit 40 that controls these mechanisms.

The mechanism of feeding the printing paper P includes the platen 26, the paper feed motor 22 for driving and rotating the platen 26, a feed assist roller (not shown), and a gear train (not shown) for transmitting the rotations of the paper feed motor 22 to the platen 26 and to the feed assist roller. The printing paper P set in the printer 20 is placed between the platen 26 and the feed assist roller and is fed by a predetermined amount corresponding to a rotation angle of the platen 26. The mechanism of reciprocating the carriage 30 includes a sliding shaft 34 that is arranged in parallel to the shaft of the platen 26 to support the carriage 30 in a sliding manner, a pulley 38 that is linked with the carriage motor 24 via an endless drive belt 36 spanned therebetween, and a position detection sensor 39 that detects the original position of the carriage 30.

The print head unit 28 mounted on the carriage 30 has six ink ejection heads 61 to 66 for ejecting corresponding color inks, black, cyan, light cyan, magenta, light magenta, and yellow. Six ink induction pipes are formed upright on the bottom of the carriage 30 to be connected to the corresponding ink ejection heads 61 to 66. Downward attachment of a black ink cartridge 70a and a color ink cartridge 70b to the carriage 30 makes insertion of the six ink induction pipes into connection holes of the respective ink cartridges 70a and 70b. The insertion causes the respective inks in the ink cartridges 70a and 70b to be sucked through the corresponding ink induction pipes by the capillary action and to be led to the corresponding ink ejection heads 61 to 66 that respectively have nozzle arrays of 32 nozzles Nz. Each nozzle Nz has an ink conduit and a piezoelectric element PE placed above the ink conduit. As is known in the art, the piezoelectric element PE has the crystal structure deformed by application of a voltage and implements extremely high-speed conversion of electrical energy into mechanical energy. In the structure of this embodiment, application of a voltage for a predetermined time width to electrodes on both ends of the piezoelectric element PE expands the piezoelectric element PE and deforms one side wall of the ink conduit. The volume of the ink conduit is reduced corresponding to the expansion of the piezoelectric element PE, and a volume of an ink corresponding to the reduced volume of the ink conduit is ejected at a high speed as an ink particle Ip from the nozzle Nz. The ink particles Ip soak into the printing paper P set on the platen 26 to create dots on the printing paper P and complete a printed image.

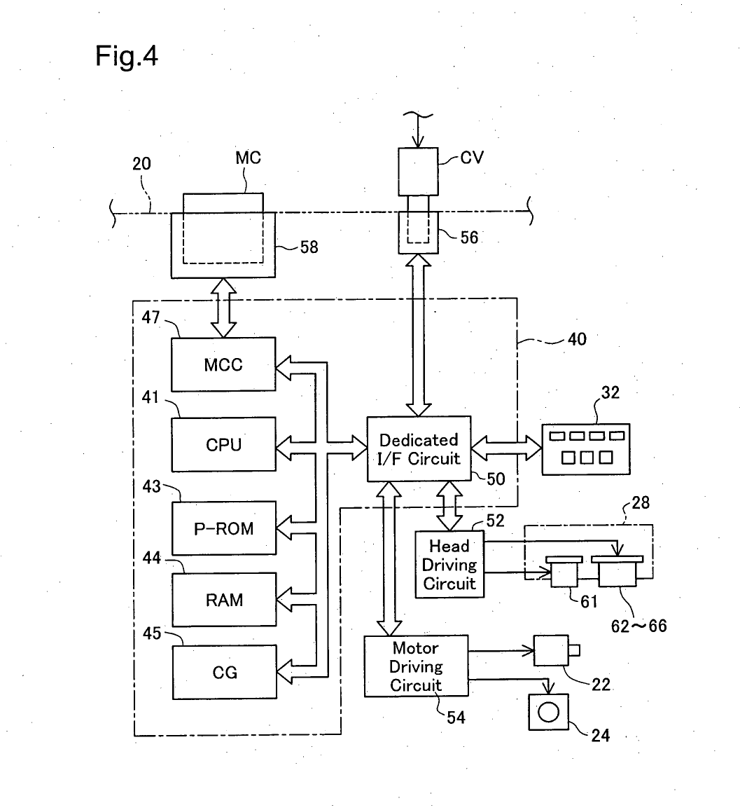

The control circuit 40 transmits signals to and from the operation panel 32 of the printer 20 and the digital still camera 12 and controls the printing operations by the paper feed motor 22, the carriage motor 24, and the print head unit 28. FIG. 4 shows the configuration of the control circuit 40. The control circuit 40 is constructed as an arithmetic logic unit including multiple elements mutually connected via a common bus, that is, a CPU 41, a P-ROM 43 that stores various printing-related programs and data required for execution of these printing-related programs, a RAM 44, a character generator 45 that stores character dot matrices, and a dedicated I/F circuit 50 that functions as an interface to external motors and other external elements. The dedicated I/F circuit 50 is connected to a head driving circuit 52 for driving and controlling the print head unit 28 and to a motor driving circuit 54 for driving and controlling the paper feed motor 22 and the carriage motor 24.

The P-ROM 43 stores an image printing program B1 specifying a series of image printing process (discussed later). The series of image printing process includes a process of combining multiple frame images to generate one high-resolution still image. The P-ROM 43 also stores a printer driver as a device driver for the printer 20. The printer driver specifies a resolution conversion process, a color conversion process, a halftoning process, and a data rearrangement process as control operations of the printer 20. The resolution conversion process converts the resolution (the number of pixels per unit length) of an original still image expressed by RGB data into the printing resolution adopted in the printer 20 (the number of dots created per unit length by the printer). The color conversion process converts one color expression format by the R, G, and B tone values into another color expression format by the C, M, Y, and K tone values. The printer 20 takes only either of two states, dot-on state or a dot-off state in each pixel to express each of the C, M, Y, and K tone values. The halftoning process accordingly converts image data expressed by the C, M, Y, and K tone values in a tone value range of 0 to 255 into dot state data expressed by a less number of tone values expressible by the printer 20. The data rearrangement process rearranges the dot state data obtained by the halftoning process in an order of transfer to the printer 20. This series of processing converts RGB data representing a still image as an object of printing into CMY data that is in a printable format by the printer 20 and represents the dot distributions of the respective colors C, LC, M, LM, Y, and K.

The dedicated I/F circuit 50 has a built-in universal serial bus interface circuit, which is connected to a USB port 56 provided on the casing of the printer 20. Connection of the digital still camera 12 to the USB port 56 via the cable CV inputs still image data and moving image data generated by the digital still camera 12 into the printer 20. The control circuit 40 also has a memory card controller (MCC) 47 connected to the common bus. The memory card controller 47 is linked to a memory card slot 58 provided on the casing of the printer 20. The printer 20 reads still image data and moving image data from the memory card MC inserted in the memory card slot 58. The memory card MC is freely attachable to and detachable from the memory card slot 58. The design of the interface may be changed appropriately for the easy connections with peripheral devices.

The memory card slot 58 is integrated with the casing of the printer 20 in the structure of this embodiment, although the memory card slot may be separate from the casing of the printer. In the latter case, the memory card slot may be connected to the printer by any of diverse cables.

The printer 20 having the hardware configuration discussed above converts the RGB data input from the digital still camera 12 into CMY data. The paper feed motor 22 is driven to rotate the platen 26 and the other relevant rollers to feed the printing paper P (sub-scan), and the carriage motor 24 is driven to reciprocate the carriage 30 (main scan). Simultaneously with the main scan, the piezoelectric elements PE of the respective ink ejection heads 61 to 66 in the print head unit 28 are actuated according to the converted CMY data to eject ink droplets of the corresponding colors and form a multi-color printed image on the printing paper P.

The image printing system PS of this embodiment includes the printer 20 that ejects inks by the functions of the piezoelectric elements PE. The technique of the invention is, however, not restricted to the printer 20 of this structure but is applicable to any printers that require conversion of image data for printing, for example, bubble jet printers that eject inks by means of bubbles produced in ink conduits with power supply to heaters located in the ink conduits, heat transfer printers, and laser printers.

A-2. Image Printing Process

The image printing system PS of the embodiment configured as discussed above executes the series of image printing process as described below. The series of image printing process includes a series of processing performed by the digital still camera 12 to generate still image data from moving image data and a series of processing performed by the printer 20 to print a still image according to the generated still image data. The CPU 12K included in the control circuit 12D of the digital still camera 12 and the CPU 41 included in the control circuit 40 of the printer 20 respectively execute the image printing program A1 stored in the. ROM 12L and the image printing program B1 stored in the P-ROM 43.

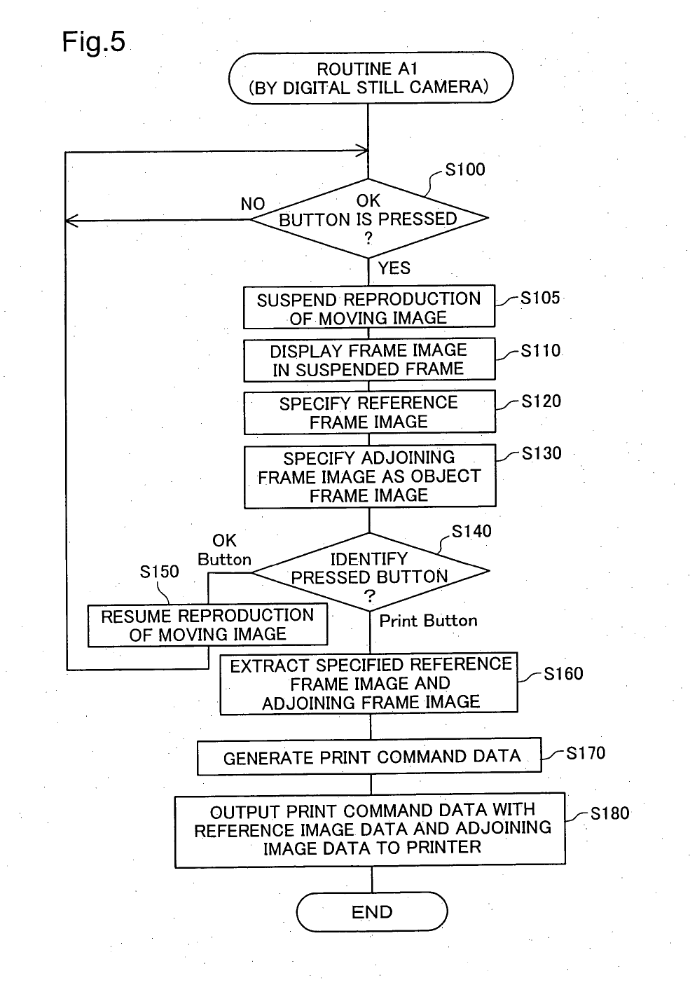

FIG. 5 is a flowchart showing a series of processing performed by the digital still camera 12 as a routine A1 of the image printing process. The routine A1 of FIG. 5 is triggered by a start of reproduction of a moving image on the digital still camera 12. In the routine A1 of the image printing process, the CPU 12K first determines whether the user presses the OK button 12R (step S100). In response to the user's press of the OK button 12R, the CPU 12K suspends the reproduction of the moving image (step S105) and displays a frame image in the suspended frame on the liquid crystal display 12G (step S110). The user's operation of the OK button 12R selects the frame image currently displayed on the liquid crystal display 12G among a large number of still images included in the reproduced moving image. The suspended frame image selected by the user's operation of the OK button 12R is hereafter referred to as reference frame image.

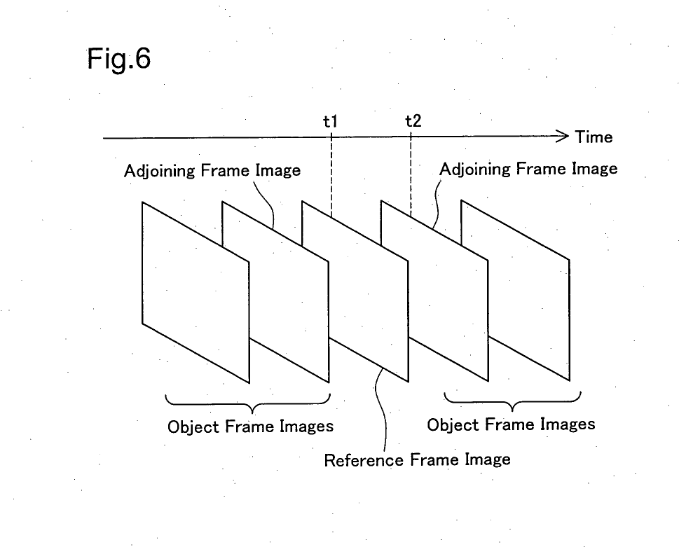

The CPU 12K specifies the currently displayed frame image as the reference frame image (step S120) and subsequently specifies a frame image consecutive to the reference frame image in time series (hereafter referred to as object frame image) (step S130). A typical positional relation of object frame images including adjoining frame images to the reference frame image is shown in FIG. 6. The preferable number of the object frame images specified at step S130 is in a range of 1 to 4 by taking into account the processing speed of a subsequent composition process (discussed later) and the quality of a resulting processed image. The procedure of this embodiment specifies an adjoining frame image located immediately after the reference frame image as the object frame image.

The CPU 12K then identifies the button pressed by the user as the Print button 12S or the OK button 12R (step S140). In response to the user's press of the OK button 12R in the pause state, the CPU 12K cancels the pause and resumes the reproduction of the moving image (step S150). The routine A1 then goes back to step S100 to wait for the user's selection of another frame image.

In response to the user's press of the Print button 12S in the pause state, on the other hand, the CPU 12K extracts the specified reference frame image and adjoining frame image from the reproduced moving image (step S160). The digital still camera 12 then generates still image data representing the extracted reference frame image (hereafter referred to as reference image data) and still image data representing the extracted adjoining frame image (hereafter referred to as adjoining image data). The CPU 12K subsequently generates data of a print command (print command data) to be given to the printer 20 (step S170) and outputs the print command data together with the reference image data and the adjoining image data to the printer 20 (step S180). This terminates the routine A1 of the image printing process.

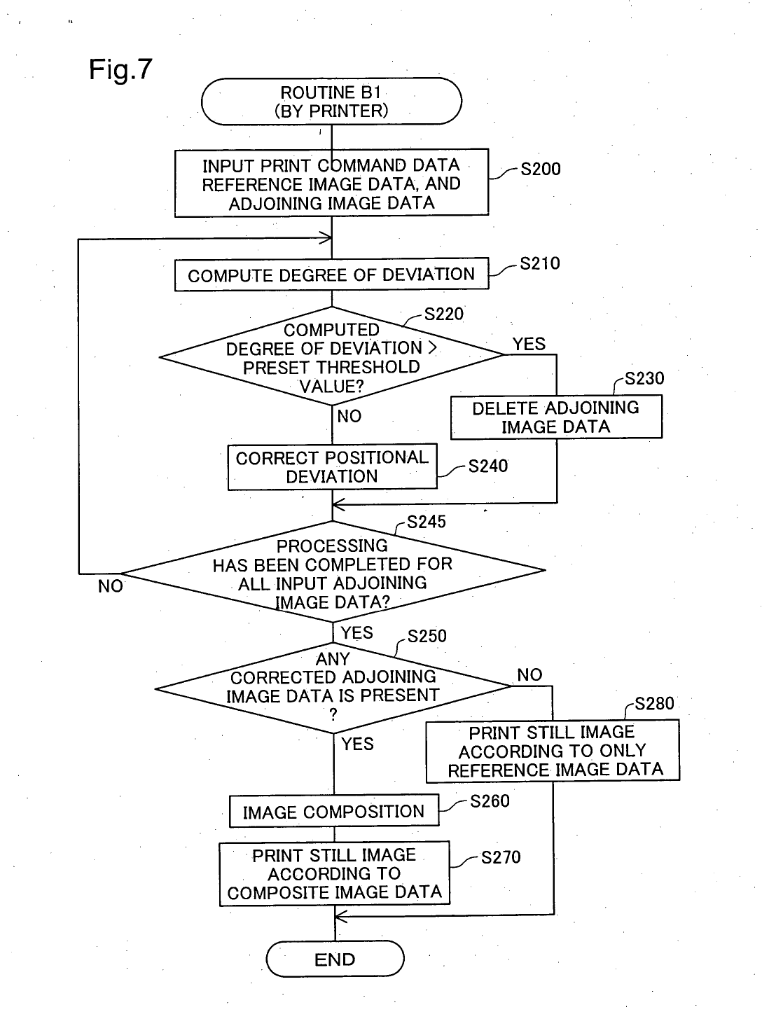

FIG. 7 is a flowchart showing a series of processing performed by the printer 20 as a routine B1 of the image printing process. The routine B1 of FIG. 7 is triggered when the control circuit 40 of the printer 20 detects input of the print command data from the digital still camera 12. In the routine B1 of the image printing process, the CPU 41 first inputs the print command data, the reference image data, and the adjoining image data from the digital still camera 12 (step S200). The CPU 41 subsequently compares the reference image data with the adjoining image data and computes a degree of deviation between the reference frame image and the adjoining frame image (step S210).

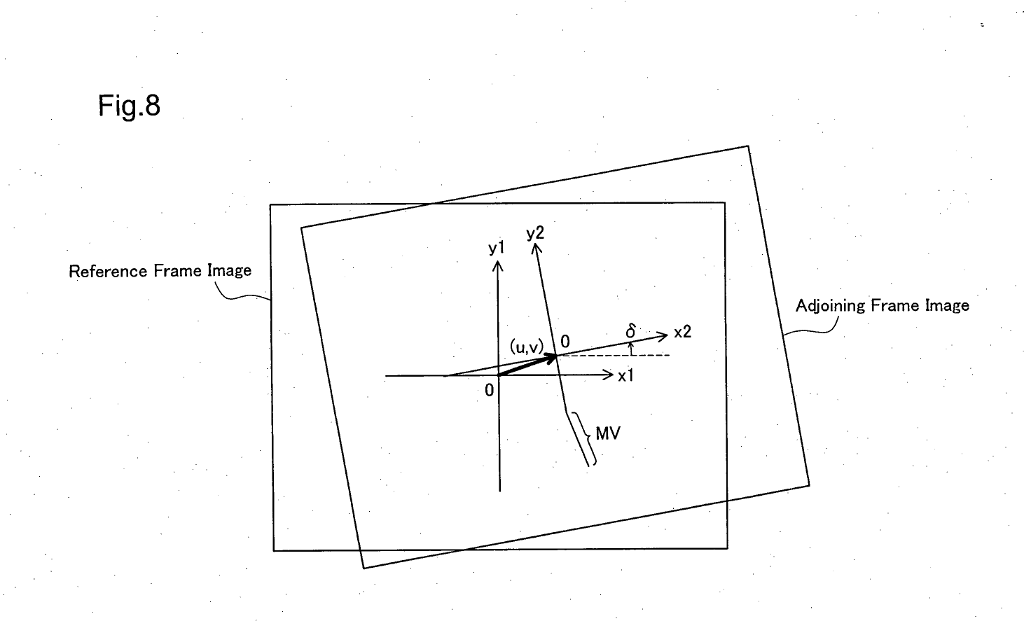

FIG. 8 shows a positional deviation between the reference frame image and the adjoining frame image. The degree of deviation computed at step S210 is a ‘positional deviation’ between two images, that is, an image having coordinate axes x1 and y1 and an image having coordinate axes x2 and y2 as shown in FIG. 8. The positional deviation is defined by three factors, translational deviations ‘u’ and ‘v’ in translational directions and a rotational deviation ‘δ’ in a rotational direction. The CPU 41 computes the degree of deviation (u,v,δ) between the reference frame image and the adjoining frame image. One typical method adopted for computation of the degree of deviation is the gradient method that estimates the positions of pixels in the smaller unit than one pixel, based on the differences in luminance of the respective pixels between the reference frame image and the adjoining frame image. The positional deviation between the reference frame image and the adjoining frame image may be ascribed to hand movement during image taking with the digital still camera 12 or to a pan or a rotation of the digital still camera 12.

Referring back to the flowchart of FIG. 7, the CPU 41 compares the computed degree of deviation with a preset threshold value (step S220). When the computed degree of deviation exceeds the preset threshold value, the CPU 41 determines inadequacy of the use of the adjoining frame image having a significant deviation from the reference frame image for printing and deletes the adjoining image data (step S230). The threshold value is set, for example, by taking into account the standard level of hand movement or a camera pan between time points t1 and t2 in FIG. 6. In a moving image taken by a standard digital camera, the hand movement or the camera pan typically causes translational deviations of several pixels and a rotational deviation of not greater than 1 degree between adjoining frame images. These typical values of the deviations are set to the threshold value. This setting effectively excludes any adjoining frame image with a significant image blur, for example, due to a quick camera pan or an intentional camera rotation, or any adjoining frame image over a scene change from the subject of composition with the reference frame image.

When the computed degree of deviation does not exceed the preset threshold value at step S220, the CPU 41 corrects the adjoining frame image in directions opposite to the deviating directions based on the computed degree of deviation, generates corrected adjoining image data representing the corrected adjoining frame image, and temporarily stores the corrected adjoining image data in the RAM 44 (step S240). In the illustrated example of FIG. 8, the correction shifts the positions of the respective pixels in the adjoining frame image by an amount ‘−u’ in the vertical direction and an amount ‘−v’ in the horizontal direction and rotates the positions of the respective pixels by an amount ‘−δ’. The corrected adjoining frame image of the coordinate axes x2 and y2 accordingly has a partial positional match with the reference frame image of the coordinate axes x1 and y1. A motion image area MV in the adjoining frame image that actually moved between the time points t1 and t2 in FIG. 6 does not have a positional match with the motion image area MV in the reference frame image by the correction as shown in FIG. 8.

The processing of steps S210 to S240 is executed repeatedly for each adjoining frame image expressed by each adjoining image data, when multiple adjoining image data are input from the digital still camera 12 at step S200. When the processing of steps S210 to S240 has been completed for all the input adjoining frame images (step S245), the CPU 41 refers to the storage of the RAM 44 and specifies the presence or the absence of any corrected adjoining image data (step S250).

In the case of the presence of any corrected adjoining image data at step S250, the CPU 41 combines the corrected adjoining image data with the reference image data to generate composite image data (step S260) and prints a still image according to the generated composite image data (step S270). This terminates the routine B1 of the image printing process. In the case of the absence of any corrected adjoining image data at step S250, on the other hand, the CPU 41 determines the lack of any adjoining frame image as the subject of composition and prints a still image according to only the reference image data (step S280), before exiting from this routine B1.

The composition of step S260 lays the corrected adjoining frame image upon the reference frame image, determines the tone values of pixels in a resulting composite image with some interpolation based on the tone values of the respective pixels in the two superposed images, and generates a set of the determined tone values of the pixels in the resulting composite image as composite image data. This embodiment adopts the known bilinear method to determine the tone values of the respective pixels, although another known method, for example, the nearest neighbor method or the bicubic method, may also be applicable.

In the printing process of step S270 or step S280, the printer driver activated by the CPU 41 converts the RGB data of the composite image data or the reference image data into CMY data, registers the converted CMY data as a print job, and controls the printer 20 to perform the registered print job. A frame image selected as a printing object from the moving image reproduced on the digital still camera 12 is accordingly printed on the printing paper P.

One possible modification may omit the processing of step S130 from the routine A1 performed by the digital still camera 12 to specify only the reference frame image and output still image data of the specified reference frame image with print command data to the printer 20. The printer 20 inputs the still image data with the print command data and prints a still image accordingly to only the still image data of the reference frame image without the correction of a positional deviation and the composition.

A-3. Functions and Effects

The image printing system PS of the first embodiment described above has the digital still camera 12 and the printer 20 that are mutually connected via the cable CV. The digital still camera 12 specifies one reference frame image selected in a reproduced moving image and outputs reference image data of the specified reference frame image with print command data to the printer 20. The printer 20 receives the print command data with the reference image data and prints a still image according to the reference image data. In the image printing system PS, the digital still camera 12 specifies a frame image as an object of printing and sends the print command with regard to the specified frame image to the printer 20. The image printing system PS of this embodiment takes advantage of the moving image reproduction display functions of the digital still camera 12 and the printing functions of the printer 20 to ensure easy and adequate printing of a desired still image included in a moving image with the printer 20. The user is not required to replace a recording medium, such as a memory card, for recording the moving image from the digital still camera 12 to the printer 20 or to give a print start command to the printer 20 after the replacement. The arrangement of the embodiment desirably simplifies the user's operations required to print a desired still image included in a moving image taken with the digital still camera 12. Even when the printer 20 has no image display functions, this arrangement enables the user to visually check each desired still image as an object of printing on the liquid crystal display 12G of the digital still camera 12, prior to printing.

In the image printing system PS of the first embodiment, the user's operation of the OK button 12R during reproduction of a selected moving image, the digital still camera 12 suspends the reproduction of the moving image and displays a frame image in the suspended frame on the liquid crystal display 12G The displayed frame image is specified as the reference frame image. The user operates the OK button 12R at any desired scene during reproduction of the selected moving image to specify a frame image as an object of printing.

In the image printing system PS of the first embodiment, in response to the user's operation of the Print button 12S, print command data with the specified reference frame image is output from the digital still camera 12 to the printer 20. The user's operation of the Print button 12S on the digital still camera 12 sends a print command to the printer 20. Namely the user can freely determine the timing of printing a desired frame image.

In the image printing system PS of the first embodiment, the digital still camera 12 extracts a still image selected as an object of printing (for example, a reference frame image) from the reproduced moving image and outputs the reference image data representing the extracted reference frame image to the printer 20. The image printing system PS of the embodiment does not require transfer of moving image data but requires output of only the still image data (for example, reference image data) from the digital still camera 12 to the printer 20 to print the user's desired still image included in the reproduced moving image. This arrangement effectively reduces the data volume output from the digital still camera 12 to the printer 20 for printing.

In the image printing system PS of the embodiment, in response to the user's operation of the OK button 12R during reproduction of a selected moving image, the digital still camera 12 specifies the user's selected reference frame image and an adjoining frame image that is consecutive to the reference frame image in time series among a large number of still images included in the reproduced moving image. The printer 20 combines the reference image data with the adjoining image data (the corrected adjoining image data) to generate composite image data and prints a still image according to the generated composite image data. The resulting printed image accordingly has the higher picture quality and the higher clearness than a printed image according to only the reference image data of one reference frame image.

In the image printing system PS of the embodiment, the printer 20 determines the adequacy or inadequacy of image composition, prior to actual composition of the reference image data with the adjoining image data. Only the adequacy judgment allows composition of these two data and leads to the printing process according to composite image data. The inadequacy judgment does not allow composition of the reference frame image and the adjoining frame image. This arrangement effectively ensures the improvement in picture quality by the image composition.

B. Second Embodiment

An image printing system of a second embodiment has a substantially identical configuration with that of the image printing system PS of the first embodiment. The like elements are expressed by the like numerals and symbols and are not specifically described here. The image printing system of the second embodiment includes the digital still camera 12 as the moving image data generation device and the printer 20 as the printing device. The primary difference from the first embodiment is that the digital still camera 12 of the second embodiment has the function of image composition (see FIG. 7), which is executed by the printer 20 in the first embodiment. The printer 20 of the second embodiment redundantly has the function of image composition. The digital still camera 12 and the printer 20 of the second embodiment accordingly have the additional function of exchanging information on the available functions.

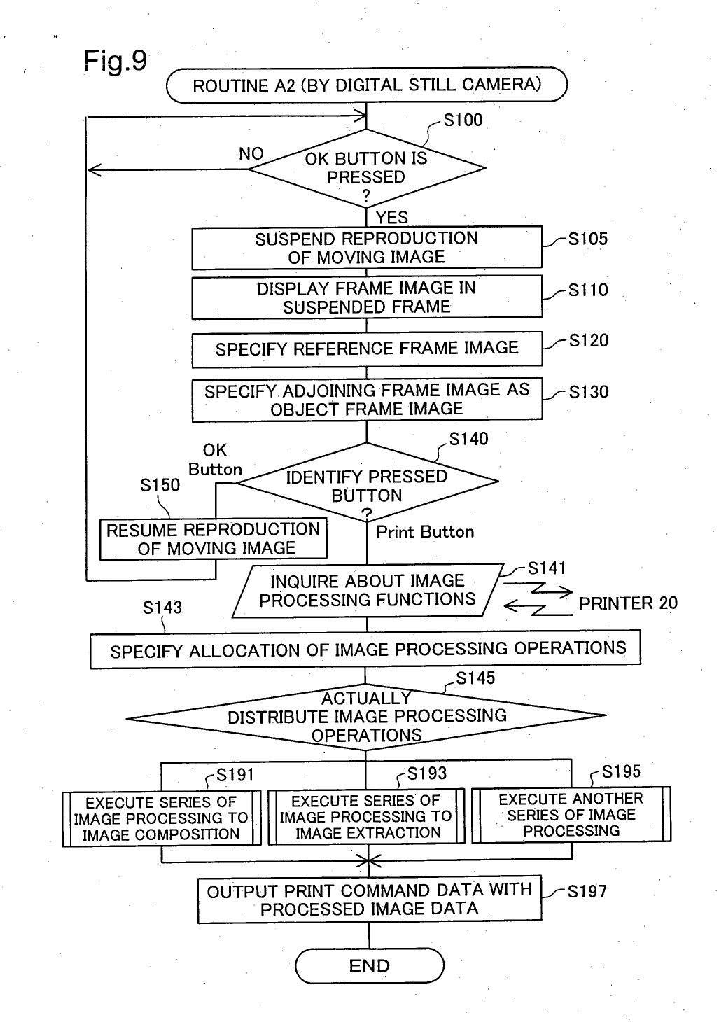

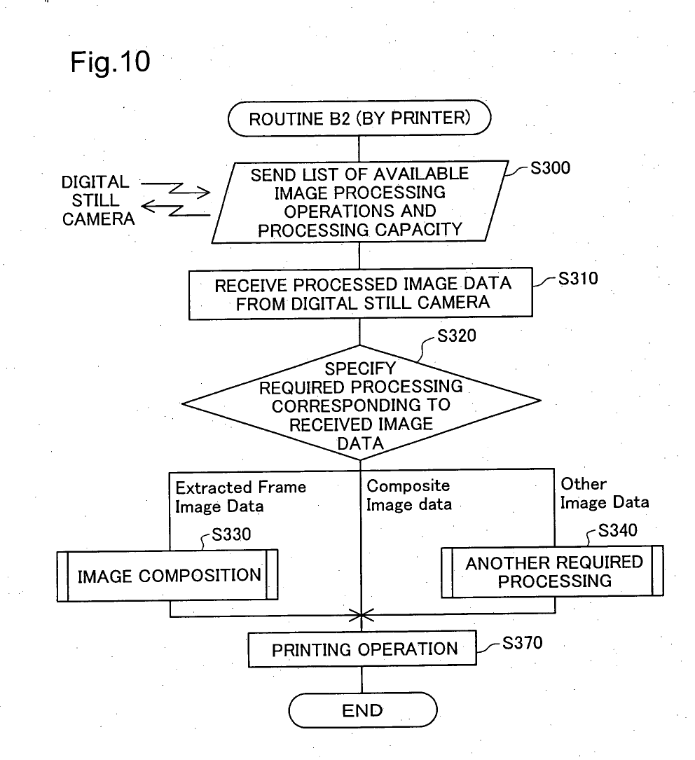

FIG. 9 is a flowchart showing a series of processing performed by the digital still camera 12 as a routine A2 of an image printing process in the second embodiment. FIG. 10 is a flowchart showing a series of processing performed by the printer 20 as a routine B2 of the image printing process in the second embodiment. The routine A2 of FIG. 9 partly matches with the routine A1 of the first embodiment shown in FIG. 5. Identical steps are shown by the identical step numbers and are not described in detail here.

Under the connection of the digital still camera 12 with the printer 20, the digital still camera 12 displays moving image data on the liquid crystal display 12G and specifies fame images as an object of printing (reference frame image and object frame image) (steps S100 to S130). This series of processing is identical with the corresponding steps of the first embodiment. In response to the user's press of the Print button 12S (step S140) after the specification of the frame images, the digital still camera 12 exchanges information on the printing-related functions with the printer 20 (step S141). In the structure of the second embodiment, the digital camera 12 inquires of the printer 20 for the image processing functions of the printer 20. Alternatively the printer 20 may inquire of the digital still camera 12 for the image processing functions of the digital still camera 12. This inquiry process may be based on a preset protocol, for example, by DPOF (digital print order format), or on an originally designed protocol.

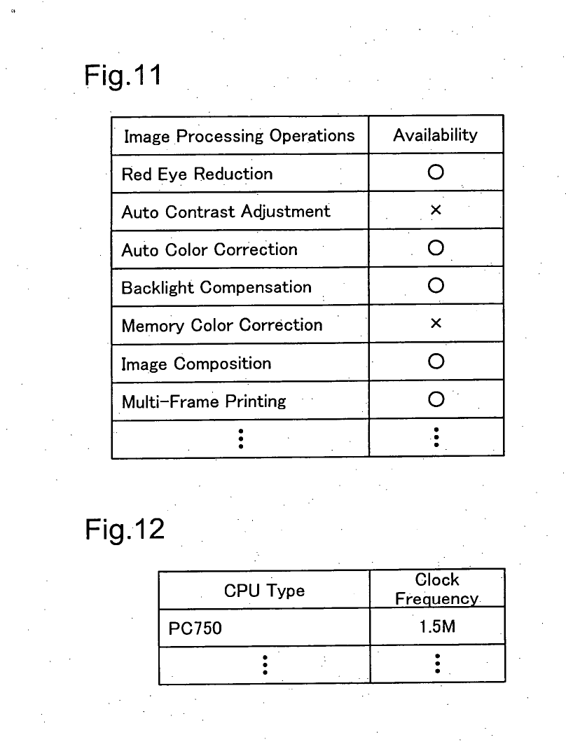

In response to the inquiry from the digital still camera 12, the printer 20 sends back a list of available image processing operations and the processing capacity to the digital still camera 12 (see step S300 in FIG. 10). As shown in FIG. 11, the list of available image processing operations specify the availabilities of conventional image processing options, for example, ‘red eye reduction’, ‘auto contrast adjustment’, ‘auto color correction’, ‘backlight compensation’, and ‘memory color correction’, as well as specific functions ‘image composition’ to combine multiple images for the enhanced resolution and the improved picture quality and ‘multi-frame printing’ to print multiple images laid out in specified positions in one page. The processing capacity of the printer 20 may be responded as the processing power of the CPU defined by, for example, the type and the clock frequency of the CPU as shown in FIG. 12. Other parameters affecting the processing speed, for example, the capacity of the main storage may additionally be responded with the processing power of the CPU. In another method, the digital still camera 12 and the printer 20 may in advance rank the processing capacity based on the processing speed as levels 1, 2, 3 . . . , and the printer 20 may respond a rank of the processing capacity to the inquiry.

The digital camera 12 refers to the response from the printer 20 and specifies the allocation of required image processing operations to the digital still camera 12 and to the printer 20 (step S143). The share of the image processing operations is determined to attain the high performance of the whole image printing system including the digital still camera 12 and the printer 20. The procedure of the second embodiment specifies the allocation of the image processing operations to minimize the total processing time. The appropriate share of the image processing operations may be determined comprehensively by taking into account other factors, as well as the total processing time. For example, one additional factor to be considered is the current state of charge of a battery in the digital still camera 12. Even when allocation of certain image processing operations to the digital still camera 12 shortens the total processing time of the whole system, most of the required image processing operations should be allocated to the printer 20 because of the expected run-out of the battery in the digital still camera 12.

The digital still camera 12 actually distributes the required image processing operations to the digital still camera 12 and to the printer 20 according to the specified allocation (step S145). In the case of allocation of a series of image processing to image composition to the digital still camera 12, for example, due to the low processing capacity of the printer 20, the digital still camera 12 performs the allocated series of image processing to the image composition (step S191) and outputs print command data with resulting composite image data to the printer 20 (step S197). The processing of step S191 is equivalent to execution of all steps S160 to S180 in the routine A1 of FIG. 5 and steps S200 to S260 in the routine B1 of FIG. 7. In this example, the digital still camera 12 outputs composite image data representing a resulting composite image to the printer 20. The printer 20 receives processed image data from the digital still camera 12 (step S310) and specifies the required processing corresponding to the received image data (step S320). In this example, the printer 20 receives the composite image data and thus immediately performs a printing operation (step S370) without any further image processing.

In the case of allocation of a series of image processing to image extraction to the digital still camera 12, on the other hand, the digital still camera 12 performs the allocated series of image processing to the image extraction (step S193) and outputs print command data with extracted image data to the printer 20 (step S197). The processing of step S193 is equivalent to execution of steps S160 to S180 in the routine A1 of FIG. 5. In this example, the printer 20 executes the image composition (step S330, see the routine B1 of FIG. 7 for the details) and performs a printing operation (step S370). In the case of another allocation to the digital still camera 12, the digital still camera 12 performs the allocated series of image processing (step S193) and outputs print command data with processed image data to the printer 20 (step S197). The printer 20 executes the required processing corresponding to the received image data (step S340) and performs a printing operation (step S370).

In the image printing system of the second embodiment, the digital still camera 12 and the printer 20 redundantly have the function of image composition and agree on activation or non-activation of their image composition functions by communication. This arrangement ensures the high performance of the whole image printing system including the digital still camera 12 and the printer 20. Namely a desired image is adequately printed according to each combination of a digital still camera and a printer having the function of image composition.

In the configuration of the second embodiment, the digital still camera 12 extracts the reference frame image and the object frame image from the reproduced moving image. When the connection between the digital still camera 12 and the printer 20 allows for high-speed data transfer, for example, USB2.0, IEEE1394, SCSI-3, or serial SCSI, the digital still camera 12 may send the user's selected moving image data to the printer 20. The printer 20 then takes charge of extraction of the reference frame image and the object frame image. The printer 20 specifies the required processing corresponding to the received image data at step S320. The printer 20 may specify the required processing in response to an instruction received from the digital still camera 12 after the response to the inquiry about the processing capacity.

In the image printing system of the second embodiment, allocation of required image processing operations is determined on the basis of the information on the image processing functions exchanged between the digital still camera 12 and the printer 20. This information exchange enables the digital still camera 12 and the printer 20 to mutually check and confirm the image processing capabilities. Such information exchange is, however, not essential. The digital still camera 12 and the printer 20 may activate a commonly possessed image processing function at the same start timing. On completion of the image processing at the earlier timing, the earlier-processed image data is used for subsequent image processing. In another possible application, the digital still camera 12 may have a selection switch between a moving image mode and a still image mode. In selection of the moving image mode, the image printing process adopts the procedure of either the first embodiment or the second embodiment to print a desired still image extracted from a moving image. In selection of the still image mode, on the other hand, the image printing process performs a conventional printing operation for still images. In the moving image mode, the printer combines received multiple image data to generate composite image data and prints a still image according to the composite image data. In the still image mode, on the other hand, the printer prints multiple still images according to received multiple image data.

C. Modifications

The embodiments discussed above are to be considered in all aspects as illustrative and not restrictive. There may be many modifications, changes, and alterations without departing from the scope or spirit of the main characteristics of the present invention. Some examples of possible modification are given below.

In the configuration of the first embodiment, the digital still camera 12 extracts specified reference frame image and adjoining frame image from a reproduced moving image (step S160 in the routine A1 of FIG. 5). The printer 20 may alternatively take charge of extraction of the specified frame images. In this modification, the digital still camera 12 specifies the reference frame image and the adjoining frame image (steps S120 and S130) and generates image identification information (for example, frame numbers) for identifying the specified reference frame image and adjoining frame image. In response to the user's press of the OK button 12R, the digital still camera 12 sends the image identification information together with selected moving image data as a subject of image extraction to the printer 20. The printer 20 extracts the reference frame image and the adjoining frame image from the received moving image data, based on the received image identification information.

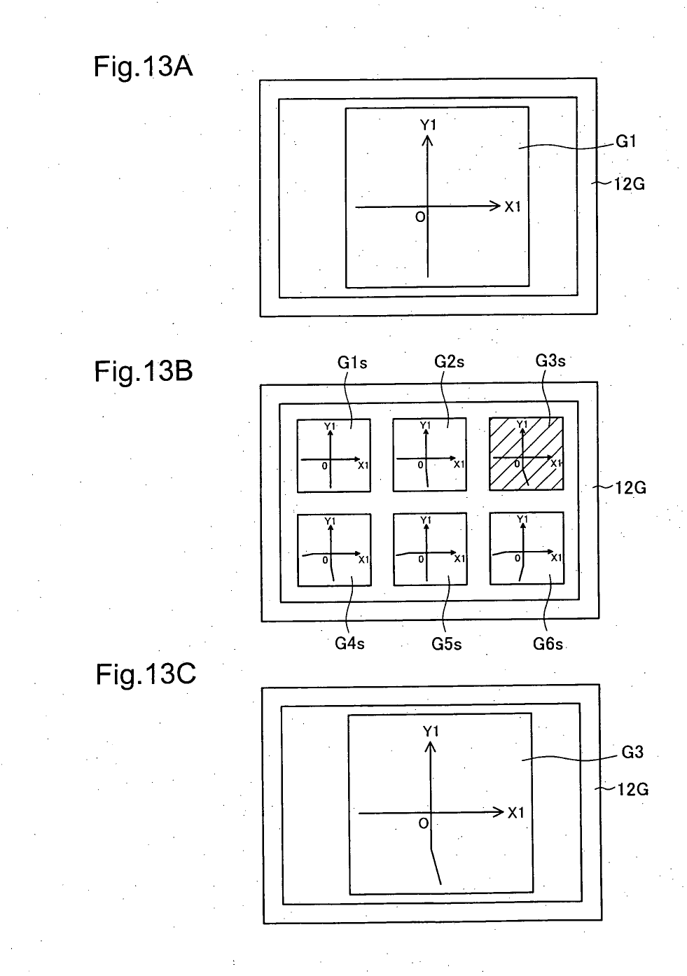

Another modified configuration enables the user to select a desired frame image as an object of printing among multiple thumbnail images displayed on the liquid crystal display 12G of the digital still camera 12. An example of display on the liquid crystal display 12G in this modified configuration is shown in FIG. 13A as a first modified example. In the illustrated example of FIG. 13A, the liquid crystal display 12G shows a frame image G1 having coordinate axes selected in response to the user's operation of the OK button 12R during reproduction of a moving image on the digital still camera 12 (see steps S100 to S110 in the routine A1 of FIG. 5). In the first modified example, the CPU 12K specifies the frame image G1 as a frame image option. In response to the user's subsequent press of an upward arrow on the arrow key 12Q, the CPU 12K detects a corresponding operation signal and specifies frame images G2 to G6 consecutive in time series to the frame image G1 as additional frame image options. The CPU 12K subsequently generates thumbnail images G1s to G6s of the respective frame images G1 to G6 as the frame image options and displays a list of the generated thumbnail images G1s to G6s on the liquid crystal display 12G as shown in FIG. 13B. The user may manipulate the rightward arrow and the leftward arrow on the arrow key 12Q to select a desired thumbnail image as an object of printing. In the illustrated example of FIG. 13B, a highlighted thumbnail image G3s is selected. In response to the user's subsequent press of the OK button 12R, the CPU 12K detects a corresponding operation signal and specifies and displays a frame image G3 corresponding to the highlighted thumbnail image G3s as a reference frame image on the liquid crystal display 12G as shown in FIG. 13C (see step S120 in the routine A1 of FIG. 5). The CPU 12K then executes the processing of steps S130 to S180 in the routine A1 of FIG. 5 in the same manner as described in the first embodiment. The enumerated display of the thumbnail images G1s to G6s may be replaced by frame-by-frame advance display of the respective frame images G1 to G6 in response to each press of the rightward arrow or the rightward arrow on the arrow key 12Q.

In the configuration of the first modified example, the user operates the OK button 12R during reproduction of the moving image to select the frame image G1 in the suspended frame. The user then manipulates the arrow key 12Q to visually check the frame images G2 to G6 consecutive in time series to the selected frame image G1 and specifies a desired image among the frame images G1 to G6 as an object of printing. This arrangement enables the user to easily specify a desired frame image as an object of printing by only the simple operations. The user is not required to repeat a set of operations (presses of the OK button 12R to suspend the reproduction and to cancel the suspension and operations of the arrow key 12Q for fast forward or fast rewind of the moving image) several times for selection of a desired frame image as an object of printing from the reproduced moving image.

In the configurations of the embodiments discussed above, the user operates the OK button 12R during reproduction of a moving image to select a desired frame image as an object of printing. A desired frame image as an object of printing may be selected by another method. For example, the digital still camera 12 adequately extracts multiple frame images from a moving image and displays the extracted multiple frame images sequentially or as a list of thumbnail images on the liquid crystal display 12G. The user operates the OK button 12R to select a desired frame image as an object of printing from the displayed image options.

In the configurations of the embodiments discussed above, the digital still camera 12 outputs the print command data to the printer 20 in response to the user's operation of the Print button 12S on the digital still camera 12. The digital still camera 12 may output the print command data to the printer 20 at another timing. For example, at a timing when a reference frame image and an adjoining frame image are specified by the user's press of the OK button 12R during reproduction of a selected moving image, the procedure may automatically generate print command data with regard to the specified reference frame image and the specified adjoining frame image and output the generated print command data to the printer 20.

In the embodiments discussed above, the procedure uses the result of comparison of the degree of deviation between the reference frame image and the adjoining frame image with the preset threshold value as the criterion to determine the adequacy or inadequacy of composition of the reference frame image and the adjoining frame image. The adequacy-inadequacy judgment is, however, not restricted to this criterion. For example, the procedure may determine the inadequacy of image composition when the brightness difference between the reference frame image and the adjoining frame image is not less than a predetermined value or when the resolution of the reference frame image or of the adjoining frame image is lower than a preset reference level.

In the structures of the embodiments and modified example, the digital still camera 12 and the printer 20 have a wired connection by the cable CV. The digital still camera 12 and the printer 20 may alternatively have a wireless connection, for example, by radio wave, infrared ray, or light.

All changes within the meaning and range of equivalency of the claims are intended to be embraced therein. The scope and spirit of the present invention are indicated by the appended claims, rather than by the foregoing description.

1. An image printing system comprising a moving image data generation device and a printing device that are connected to each other, said moving image data generation device taking a moving image of a subject to generate moving image data, while said printing device printing an image according to image data received from said moving image data generation device,
said moving image data generation device comprising:
a reproduction module that reproduces the moving image according to the generated moving image data in a visually recognizable manner;
a selection module that selects a still image from the reproduced moving image in response to a user's preset instruction;
a specification module that specifies at least one still image in response to the selection by said selection module; and
a print command output module that outputs a print command with regard to the specified still image to said printing device,
said printing device receiving the print command output from said moving image data generation device and printing a still image that is equivalent to the specified still image.

2. An image printing system in accordance with claim 1, wherein said selection module selects the still image in response to the user's preset operation of an operation unit during reproduction of the moving image.

3. An image printing system in accordance with either one of claims 1 and 2, wherein said print command output module outputs the print command to said printing device in response the user's predetermined operation of an operation unit.

4. An image printing system in accordance with claim 1, wherein said moving image data generation device further comprises:
an option display module that displays the still image selected by said selection module and a still image consecutive to the selected still image as multiple still image options for printing; and
a reselection module that reselects a still image among the displayed multiple still image options in response to the user's specified operation of an operation unit during the display, and
said specification module specifies at least one still image in response to the reselection by said reselection module.

5. An image printing system in accordance with claim 1, wherein said moving image data generation device further comprises:
a data output module that extracts the at least one still image specified by said specification module from the moving image and outputs still image data representing the extracted still image to said printing device, and
said printing device receives the still image data output by said data output module and prints the still image according to the received still image data.

6. An image printing system in accordance with claim 1, wherein said specification module specifies the selected still image and an adjoining still image adjacent to the selected still image, and
said printing device further comprises an image composition printing module that combines still image data representing the selected still image with still image data representing the adjoining still image to generate composite still image data and prints the still image according to the composite still image data.

7. An image printing system in accordance with claim 6, wherein said printing device further comprises an adequacy judgment module that determines adequacy or inadequacy of image data composition between the still image data representing the selected still image and the still image data representing the adjoining still image, based on a preset criterion,
when said adequacy judgment module determines adequacy of the image data composition, said image composition printing module prints the still image according to the composite still image data.

8. An image printing system comprising a moving image data generation device and a printing device that are connected to each other, said moving image data generation device taking a moving image of a subject to generate moving image data, while said printing device printing an image on a printing medium according to image data received from said moving image data generation device,
said image printing system comprising:
a reproduction module that reproduces the moving image according to the generated moving image data in a visually recognizable manner;
a still image specification module that specifies at least one still image and at least one adjacent still image consecutive to the at least one still image in the reproduced moving image;
an image composition module that combines still image data representing the at least one still image with still image data representing the at least one adjacent still image to generate composite still image data; and
a printing module that prints a still image according to still image data,
wherein at least part of said modules is incorporated redundantly in both said moving image data generation device and said printing device.

9. An image printing system in accordance with claim 8, wherein said reproduction module and said still image specification module are incorporated in said moving image data generation device, and
said image composition module and said printing module are incorporated in said printing device.

10. An image printing system in accordance with claim 8, wherein said reproduction module is incorporated in said moving image data generation module, and
said still image specification module, said image composition module, and said printing module are incorporated in said printing device.

11. An image printing system in accordance with claim 8, wherein said moving image data generation device comprises a moving image data output module that outputs the generated moving image data to said printing device, and
said printing device comprises said reproduction module, said still image specification module, said image composition module, and said printing module,
said printing device receiving the moving image data output from said moving image data generation device, processing the received moving image data, and printing a composite still image according to the generated composite still image data.

12. An image printing system in accordance with claim 8, wherein said moving image data generation device comprises:
an inquiry module that inquires of said printing device for information on a processing capability of the image composition;
a processing allocation determination module that refers to the information on the processing capability of the image composition sent from said printing device in response to the inquiry, and determines allocation of an image processing operation of specifying the still images and an image processing operation of combining the specified still images to said printing device or to said moving image data generation device; and
a processing control module that notifies said printing device of the determined allocation of the image processing operations and controls execution of each image processing operation allocated to said moving image data generation device.

13. An image printing system in accordance with claim 12, wherein said processing allocation determination module comprises:
an assessment module that refers to the information on the processing capability of the image composition sent from said printing device in response to the inquiry and determines whether the processing capability of said printing device is higher than the processing capability of said moving image data generation device; and
an image composition allocation module, when said assessment module determines that the processing capability of said printing device is higher than the processing capability of said moving image data generation device, allocates the image processing operation of combining the specified still images to said printing device.

14. An image printing system in accordance with claim 8, wherein said moving image data generation device comprises:
a mode selection module that selects either of a moving image mode and a still image mode as image data to be processed; and
an image print control module that, in response to selection of the still image mode by said mode selection module, controls said printing module to print the still image according to the still image data without the image composition performed by said image composition module.

15. An image printing system in accordance with claim 8, wherein said moving image data generation device comprises:
a mode selection module that selects either of a moving image mode and a still image mode as image data to be processed; and
a composite image print control module that, in response to selection of the moving image mode by said mode selection module, activates said image composition module to generate the composite still image data and controls said printing module to print a composite still image according to the generated composite still image data.

16. An image printing system in accordance with claim 15, wherein said moving image data generation device further comprises:
a still image print control module that, in response to selection of the still image mode by said mode selection module, prohibits activation of said still image specification module and said image composition module, directly outputs still image data representing a still image selected from the moving image to said printing module, and controls said printing module to print the selected still image according to the output still image data.

17. A moving image data generation device included in an image printing system in accordance with either one of claims 1 and 8.

18. A printing device included in an image printing system in accordance with either one of claims 1 and 8.

19. An image printing method that causes a printing device to print a still image on a printing medium according to image data received from a moving image data generation device, said image data generation device being connected to said printing device and taking a moving image of a subject to generate moving image data,
said image printing method comprising:
reproducing the moving image according to the moving image data in a visually recognizable manner on a display unit of said moving image data generation device;
specifying one still image among a large number of still images constituting the reproduced moving image;
outputting still image data representing the specified still image and a print command with regard to the specified still image to said printing device, in response to a preset operation of said moving image data generation device; and
causing said printing device to print a still image that is equivalent to the specified still image, in response to the input print command.

20. An image printing method that causes a printing device to print a still image on a printing medium according to image data received from a moving image data generation device, said image data generation device being connected to said printing device and taking a moving image of a subject to generate moving image data,
said image printing method comprising:
reproducing the moving image according to the moving image data in a visually recognizable manner on a display unit having a moving image display function;
specifying at least one still image and at least one adjacent still image consecutive to the at least one still image in the reproduced moving image;
combining still image data representing the at least one still image with still image data representing the at least one adjacent still image to generate composite still image data; and
causing said printing device to print a composite still image according to the generated composite still image data,
wherein at least part of said steps is redundantly executable by both said moving image data generation device and said printing device.
